(19) United States
(12) Patent Application Publication
(10) Pub. No.: US 2022/0340355 A1
(43) Pub. Date: Oct. 27, 2022

(54) Gumball Machine Shirt

(71) Applicant: Jomoko Graves, Toledo, OH (US)

(72) Inventor: Jomoko Graves, Toledo, OH (US)

(21) Appl. No.: 17/687,617

(22) Filed: Mar. 5, 2022

Related U.S. Application Data
(60) Provisional application No. 63/258,315, filed on Apr. 26, 2021.

(51) Int. Cl. B65D 83/04; A41B 1/08; G07F 11/62

(52) U.S. Cl. CPC B65D 83/0409; A41B 1/08; G07F 11/62

(57) ABSTRACT

A shirt having an attached dispensing apparatus adapted to fit or be inserted within the material of the shirt. The dispensing apparatus has a dispenser body and container section with attachment flanges to enable at least one gasket and screw surrounding the dispenser body and container section to adhere to shirt. The gumball machine shirt holds at least one item to be dispensed.

### BRIEF SUMMARY OF CURRENT ART

The present invention relates generally to dispensing apparatus' or more specifically, to a gumball machine embedded in a shirt. Transforming an ordinary shirt and subsequently the wearer into a gumball machine. Multiple items such as gumballs or candy may be placed within the containment section, which typically may be made from a clear material such as plastic or rubber.

### BRIEF DESCRIPTION OF DRAWINGS

FIG. 1 Illustrates a two dimensional perspective view of a gumball machine device assembled with (1) bulk container, (2) container flange, (3) gasket, (4) dispenser body, (5) coin mesh, (6) gum shute (7) screws.

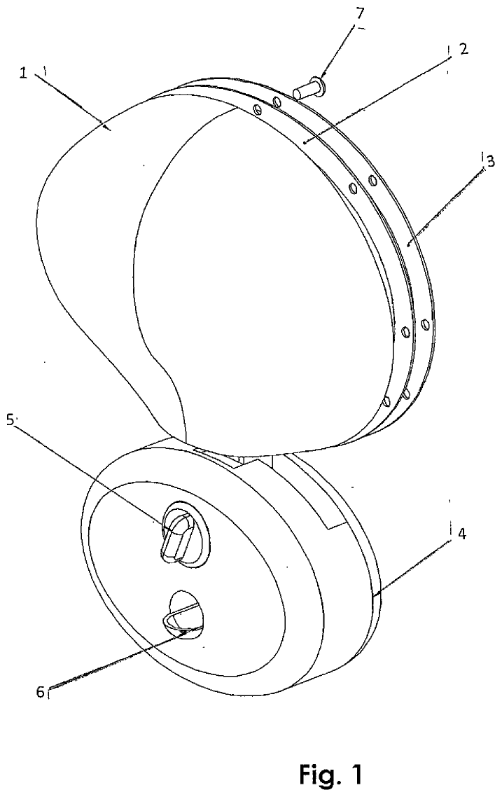

FIG. 2 Illustrates the design of the gumball machine device assembled with a shirt. (1) bulk container, (2) container flange, (4) dispenser body (5) coin mesh, (6) gum shute.

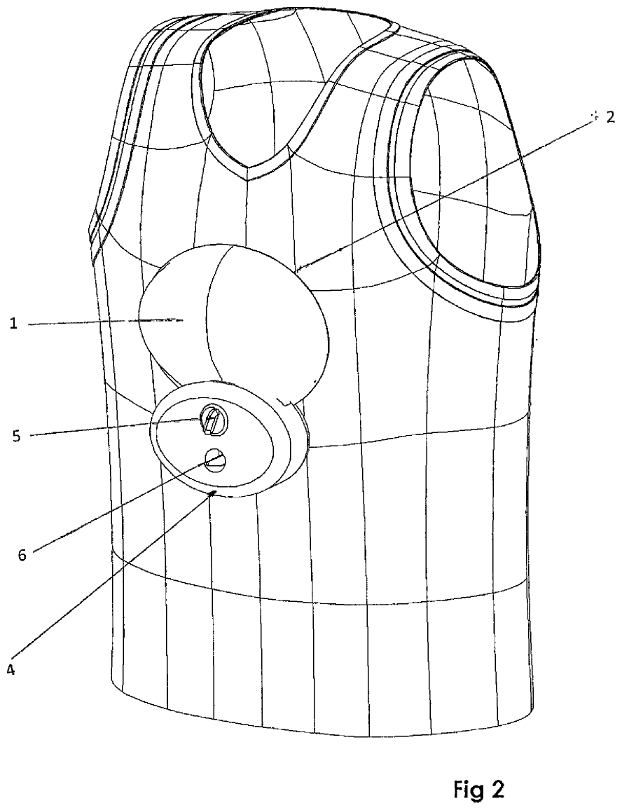

FIG. 3 Illustrates an exploded view of a gumball machine device assemble with (5) coin mesh, (6) gumball shute, (8) dispenser and bulk container body, (9) transparent cover, (10) threaded shaft and shaft nut assembly, (11) specialized bracket, (12) bulk container cover, (13) dispenser assembly and cover, (14) bar shaft.

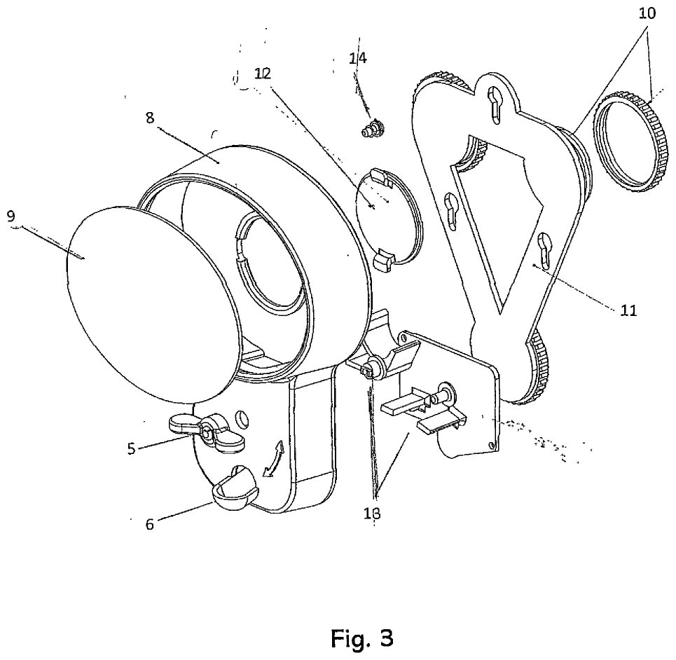

The shirt and dispensing apparatus can be provided in any size but preferred size is one where the shirt and dispensing apparatus are proportionate to each other, and the dispensing apparatus is centered on the shirt. Where the user or other person can turn the coin mesh and easily dispense and receive gum or candy in his or her hand. This size and shape of the dispenser apparatus will also allow the dispenser apparatus to easily be packaged to shirt.

Thus, the present invention provides a gumball machine shirt that can be sized and shaped to fit any person. The gumball machine shirt can be easily operated for use to automatically dispense the gum or candy contained therein by simply turning the coin mesh that subsequently activates the dispensing wheel to dole out gum or candy.

The above detailed description is for the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices, components, mechanisms and methods are omitted so as to not obscure the description of the present invention with unnecessary detail. The principle here is the marrying of a shirt and dispensing apparatus to function as one innovation.

### Patent Citations (6)

Publication number: U.S. Pat. No. 9,688,460B1

Priority date: Jun. 23, 2016

Publication date: Jun. 27, 2017

Assignee: Sweet N Fun Ltd

Title: Candy Dispenser

Publication number: U.S. Pat. No. 4,354,619

Priority date: Jun. 1, 1979

Publication date: Oct. 19, 1982

Assignee: Bramlage Gmbh

Title: Container for the dispensing of tablets one by one

Publication number: U.S. Pat. No. 5,178,298A

Priority date: Feb. 12, 1992

Publication date: Jan. 12, 1993

Assignee: Allina Curtis J

Title: Candy Dispenser

Publication number: US20070114239A1

Priority date: Nov. 18, 2005

Publication date: May 24, 2007

Assignee: Seaquist Closures Foreign, Inc.

Title: Tablet Dispenser

Publication number: U.S. Pat. No. 7,988,016B2

Priority date: Feb. 6, 2008

Publication date: Aug. 2, 2011

Assignee: Klein Seth A

Title: Medicine Container with Single Pill Dispenser

Publication number: U.S. Pat. No. 9,126,742B2

Priority date: Feb. 25, 2010

Publication date: Sep. 8, 2015

Assignee: Radz Brands Llc

Title: Novelty Dispenser

### CONCLUSION

What is claimed herein the foregoing patent application is a gumball machine shirt, which is a novelty, garment and/or toy that may provide utility in dispensing gum or candy all while wearing the innovation. The patent petitioner has married together and enhanced a shirt and dispenser apparatus to function as one unique unit.

Therefore, for the outlined reasons herein, it is respectfully submitted that this application is now in condition for a timely Notice of Allowance and early notice of the same is earnestly requested.

What is claimed is:

1. A gumball machine shirt, composing:
a shirt;
where said shirt has attached thereto a standard functioning dispensing apparatus;
where said dispensing apparatus assembly composes;
a dispenser body having an outer surface with a flange that may attach to said shirt with the assistance of a gasket and at least one screw and shaft nut;
where said gasket having but not limited to identical perimeter shape of dispenser body;
and where said dispenser body has an interior wall, the wall having a recessed opening that is recessed from the outer surface of the dispenser body;
the interior wall acts as an reservoir piece seated inside the dispenser body and having a bulk container section that holds at least one item to be dispensed;
where said bulk container section has an exterior wall with a flange that may attach to said shirt with the assistance of a gasket and at least one screw and shaft nut;
where said gasket having but not limited to identical perimeter shape of bulk container;
where said bulk container having an enclosing wall, a base and reservoir opening provided in the enclosing wall that communicates with the interior of the dispenser body section, and a coin mesh and dispenser wheel element positioned between the base of the bulk container section and dispenser body section;
where said coin mesh may receive coins and deposit them and simultaneously activate the dispenser wheel;
and where said dispenser wheel is a biasing element having a normal bias that normally biases the base of the bulk container interior wall to a non-dispensing position where the bulk container interior wall opening and dispenser body interior wall opening are not aligned;
and wherein bulk container interior wall opening and dispenser body interior wall opening can be brought together by the turning of the coin mesh and subsequently dispenser wheel to align both bulk container and dispenser body interior wall openings to arrive at dispensing position;

2. A gumball machine shirt, composing:
a shirt;
where said shirt has attached thereto a standard functioning dispensing apparatus;
where said dispensing apparatus assembly composes;
a combined dispenser and bulk container body having an outer surface with at least one bar shaft at rear of dispenser and bulk container body that may attach to a specialized bracket;
where said specialized bracket has at least one receiving end for said dispenser and bulk container body bar shaft;
and where said specialized bracket may attach to said shirt by means of at least one threaded shaft and shaft nut;
and where said dispenser and bulk container body has an interior wall that separates the bulk container and dispenser sections;
where said the wall having a recessed opening that is recessed from the outer surface of the dispenser body section;
the interior wall acts as an reservoir piece seated inside the dispenser body and having a bulk container section that holds at least one item to be dispensed;
dispenser body section, and a coin mesh and dispenser wheel element positioned between the base of the bulk container section and dispenser body section;
where said coin mesh may receive coins and deposit them and simultaneously activate the dispenser wheel;
and where said dispenser wheel is a biasing element having a normal bias that normally biases the base of the bulk container interior wall to a non-dispensing position where the bulk container interior wall opening and dispenser body interior wall opening are not aligned;
and wherein bulk container interior wall section opening and dispenser body interior wall section opening can be brought together by the turning of the coin mesh and simultaneously activating the dispenser wheel to align both bulk container and dispenser body interior wall openings to arrive at dispensing position;

3. The gumball machine shirt of claim 1, wherein the dispenser apparatus may be attached to shirt by means of a velcro gasket; the gasket being assembled on both the shirt and dispenser apparatus.
